(19) United States
(12) Patent Application Publication
(10) Pub. No.: US 2026/0020101 A1
(43) Pub. Date: Jan. 15, 2026

(54) DRX CYCLE DETERMINATION METHOD AND APPARATUS

(71) Applicant: BEIJING XIAOMI MOBILE SOFTWARE CO., LTD., Beijing (CN)

(72) Inventors: Qin MU, Beijing (CN); Xuemei QIAO, Beijing (CN); Song LI, Beijing (CN)

(73) Assignee: BEIJING XIAOMI MOBILE SOFTWARE CO., LTD., Beijing (CN)

(21) Appl. No.: 18/994,743

(22) PCT Filed: Jul. 29, 2022
(86) PCT No.: PCT/CN2022/109260

§ 371 Date: Jan. 15, 2025

(51) Int. Cl. H04W 76/28

(52) U.S. Cl. CPC H04W 76/28

(57) ABSTRACT

A method for determining a discontinuous reception (DRX) cycle, includes: receiving a first DRX cycle sent by a network device, in which the first DRX cycle is determined on the basis of an artificial intelligence (AI) model, and the AI model corresponds to a service type set which are operated by the terminal.

### CROSS-REFERENCE TO RELATED APPLICATIONS

This application is a U.S. National Phase of International Application No. PCT/CN2022/109260, filed on Jul. 29, 2022, the entire content of which is incorporated herein by reference.

### TECHNICAL FIELD

The present disclosure relates to a field of communication technology, and specifically to a method and an apparatus for determining a discontinuous reception (DRX) cycle, a device and a storage medium.

### BACKGROUND

In a communication system, a 5th generation mobile communication technology (5G) network may reduce energy consumption of a terminal via a discontinuous reception (DRX) mechanism. By configuring a long short-term sleep cycle for the terminal, the energy consumption is reduced. Since a fixed sleep duration set by a traditional DRX mechanism leads to large data transmission delay, artificial intelligence (AI) may be used to predict arrival time of a data packet of the terminal so as to reduce the energy consumption of the terminal. For example, a long short-term memory (LSTM) network may be used to configure a DRX cycle for the terminal.

### SUMMARY

According to an aspect of embodiments of the present disclosure, a method for determining a DRX cycle is provided, executed by a terminal, including:

receiving a first DRX cycle sent by a network device, in which the first DRX cycle is determined based on an artificial intelligence (AI) model, and the AI model corresponds to a service type set run by the terminal.

According to another aspect of embodiments of the present disclosure, a method for determining a DRX cycle is provided, executed by a network device, including:

sending a first DRX cycle to a terminal, in which the first DRX cycle is determined based on an AI model, and the AI model corresponds to a service type set run by the terminal.

According to another aspect of embodiments of the present disclosure, a terminal is provided, including a processor and a memory for storing a computer program. When the processor executes the computer program stored in the memory, the terminal is caused to implement the method according to an aspect of the embodiments above.

According to another aspect of embodiments of the present disclosure, a network device is provided, including a processor and a memory for storing a computer program. When the processor executes the computer program stored in the memory, the network device is caused to implement the method according to another aspect of the embodiments above.

According to another aspect of embodiments of the present disclosure, a computer-readable storage medium for storing instructions is provided. When the instructions are executed, the method according to an aspect of the embodiments is realized.

According to another aspect of embodiments of the present disclosure, a computer-readable storage medium for storing instructions is provided. When the instructions are executed, the method according to another aspect of the embodiments is realized.

### BRIEF DESCRIPTION OF THE DRAWINGS

These and other aspects and advantages of embodiments of the present disclosure will become apparent and more readily appreciated from the following descriptions made with reference to the accompanying drawings.

FIG. 1 is a flowchart of a method for determining a DRX cycle according to an embodiment of the present disclosure.

FIG. 2 is a flowchart of a method for determining a DRX cycle according to another embodiment of the present disclosure.

FIG. 3 is a flowchart of a method for determining a DRX cycle according to another embodiment of the present disclosure.

FIG. 4 is a flowchart of a method for determining a DRX cycle according to another embodiment of the present disclosure.

FIG. 5 is a flowchart of a method for determining a DRX cycle according to another embodiment of the present disclosure.

FIG. 6 is a flowchart of a method for determining a DRX cycle according to another embodiment of the present disclosure.

FIG. 7 is a flowchart of a method for determining a DRX cycle according to another embodiment of the present disclosure.

FIG. 8 is a flowchart of a method for determining a DRX cycle according to another embodiment of the present disclosure.

FIG. 9 is a flowchart of a method for determining a DRX cycle according to another embodiment of the present disclosure.

FIG. 10 is a flowchart of a method for determining a DRX cycle according to another embodiment of the present disclosure.

FIG. 11 is a flowchart of a method for determining a DRX cycle according to another embodiment of the present disclosure.

FIG. 12 is a flowchart of a method for determining a DRX cycle according to another embodiment of the present disclosure.

FIG. 13 is a flowchart of a method for determining a DRX cycle according to another embodiment of the present disclosure.

FIG. 14 is a flowchart of a method for determining a DRX cycle according to another embodiment of the present disclosure.

FIG. 15 is a flowchart of a method for determining a DRX cycle according to another embodiment of the present disclosure.

FIG. 16 is a flowchart of a method for determining a DRX cycle according to another embodiment of the present disclosure.

FIG. 17 is a flowchart of a method for determining a DRX cycle according to another embodiment of the present disclosure.

FIG. 18 is a flowchart of a method for determining a DRX cycle according to another embodiment of the present disclosure.

FIG. 19 is a flowchart of a method for determining a DRX cycle according to another embodiment of the present disclosure.

FIG. 20 is a flowchart of a method for determining a DRX cycle according to another embodiment of the present disclosure.

FIG. 21 is a block diagram of an apparatus for determining a DRX cycle according to an embodiment of the present disclosure.

FIG. 22 is a block diagram of an apparatus for determining a DRX cycle according to another embodiment of the present disclosure.

FIG. 23 is a block diagram of an apparatus for determining a DRX cycle according to another embodiment of the present disclosure.

FIG. 24 is a block diagram of an apparatus for determining a DRX cycle according to another embodiment of the present disclosure.

FIG. 25 is a block diagram of an apparatus for determining a DRX cycle according to another embodiment of the present disclosure.

FIG. 26 is a block diagram of an apparatus for determining a DRX cycle according to another embodiment of the present disclosure.

FIG. 27 is a block diagram of a terminal according to an embodiment of the present disclosure.

FIG. 28 is a block diagram of a network device according to an embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

The terms used in the embodiments of the present disclosure are solely for the purpose of describing a particular embodiment and are not intended to limit the embodiments of the present disclosure. The terms “a” and “the” in the singular form used in the embodiments and claims of the disclosure are also intended to include the plural form, unless the context clearly indicates other meaning. It may be understood that the term “and/or” as used herein refers to any or all possible combinations of one or more associated listed items.

It may be understood that although the terms first, second, third, etc. may be used to describe various information in the embodiments of the present disclosure, such information should not be limited to these terms. These terms are used only to distinguish information in the same type from one another. For example, without departing from the scope of the embodiments of the present disclosure, the first information may also be referred to as the second information, and likewise the second information may be referred to as the first information. Depending on the context, the word “if” used here may be interpreted as “when”, “while” or “in response to determining”.

In a communication system, a 5th generation mobile communication technology (5G) network may reduce energy consumption of a terminal via a discontinuous reception (DRX) mechanism. By configuring a long short-term sleep cycle for the terminal, the energy consumption is reduced. A traditional DRX mechanism usually sets a fixed sleep duration, which may not adapt to a change of arrival time of a data packet, and may lead to a large delay.

Therefore, a method of using the artificial intelligence (AI) to predict the arrival time of the data packet of the terminal may be studied, and a DRX sleep cycle may be dynamically adjusted according to a prediction result, so that the terminal may accurately wake up before the arrival of the data packet and enter a sleeping state when no data packet arrives, so as to reduce the energy consumption of the terminal as far as possible when a delay of data transmission is ensured.

In an embodiment of the present disclosure, many service types may run in the terminal. The service type includes, for example, an online game service type, a video service type, a web browsing service type, etc. Different service types correspond to different arrival rules of the data packet. When one AI model is used to determine the DRX sleep cycle, inherent characteristic of services may not be extracted respectively, which affects precision of cycle reasoning and makes low accuracy of the DRX sleep cycle determination.

In an embodiment of the present disclosure, a recurrent neural network (RNN) in the AI have shown an incredible result in predicting a future value for a given sequence. A long short-term memory (LSTM) is a popular RNN that is specifically designed to learn a long-term dependency of a sequence to predict a future value of the sequence. A long-term dependency refers to a sequence whose predicted output value depends on a long sequence of previous input values, rather than a unique previous input value.

Exemplarily, in an embodiment of the present disclosure, a jitter delay sequence of historical packet arrivals may be used as training data to train the LSTM model, and then a trained model is used to, when each data packet arrives, predict a jitter delay value when a next packet arrives. This method may obtain good performance in most cases, making an average error of prediction small.

Exemplarily, in an embodiment of the present disclosure, a base station may, for example, predict the arrival time of a next data packet on a terminal via the LSTM network when each data packet arrives, and then configure a DRX sleep cycle of the terminal according to a predicted result to ensure that the terminal wakes up before a data packet arrives, and the terminal is in a sleeping state when no packet arrives.

A method and an apparatus for determining a DRX cycle, a device, and storage medium are described in detail with reference to the accompanying drawings below.

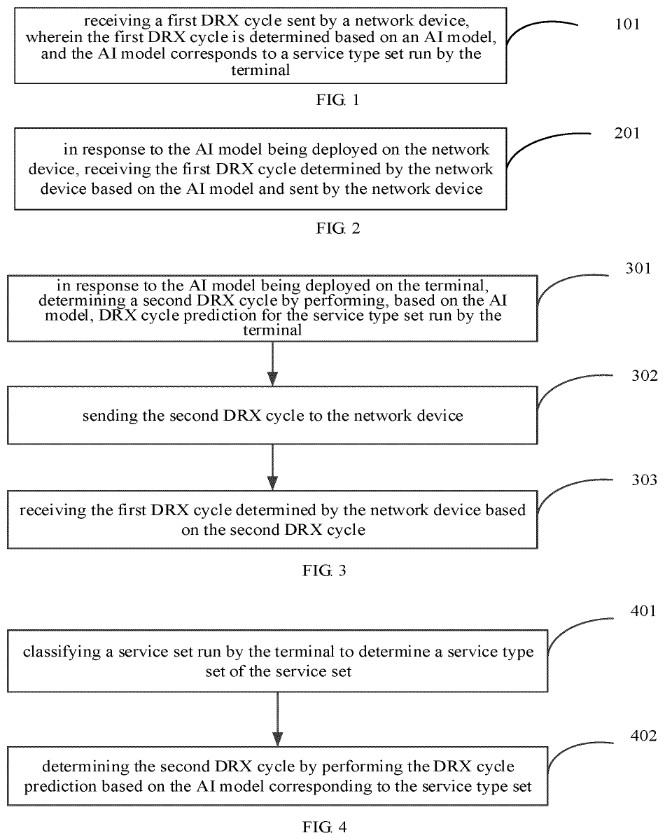

FIG. 1 is a flowchart of a method for determining a DRX cycle according to the embodiments of the present disclosure. The method is performed by a terminal. As shown in FIG. 1, the method may include the following step 101.

At step 101, a first DRX cycle sent by a network device is received, in which the first DRX cycle is determined based on an AI model, and the AI model corresponds to a service type set run by the terminal.

It should be noted that in an embodiment of the disclosure, the terminal may be a device providing a voice and/or data connectivity for a user. The terminal may communicate with one or more core networks via a radio access network (RAN), and the terminal may be an Internet of Things (IOT) terminal, such as a sensor device, a mobile phone (or referred to as “cellular” phone), and a computer with the IoT terminal, such as a fixed, portable, compact, handheld, computer built-in or vehicle-mounted apparatus. For example, it may be a station (STA), a subscriber unit, a subscriber station, a mobile station, a mobile, a remote station, an access point, a remote terminal, an access terminal, a user terminal, or a user agent. Or, the terminal may also be a device of an unmanned aerial vehicle. Or, the terminal may also be a vehicle-mounted device, such as a driving computer with a wireless communication function or a wireless communication device externally connected to the driving computer. Or, the terminal may also be a roadside device, such as a street lamp, a signal lamp or other roadside devices with a wireless communication function, etc.

In an embodiment of the present disclosure, the first DRX cycle is a cycle determined by a network side and sent to a terminal. The word “first” in the first DRX cycle is only used to distinguish it from other DRX cycles and does not specifically refer to a fixed cycle.

For example, in an embodiment of the present disclosure, when the terminal receives the first DRX cycle sent by the network device, the terminal may receive data packets based on the first DRX cycle, so as to reduce energy consumption of the terminal when data transmission delay is ensured.

In an embodiment of the present disclosure, receiving the first DRX cycle sent by the network device includes:

in response to the AI model being deployed on the network device, receiving the first DRX cycle determined by the network device based on the AI model and sent by the network device.

Exemplarily, in an embodiment of the present disclosure, receiving the first DRX cycle sent by the network device includes:

in response to the AI model being deployed on the terminal, determining a second DRX cycle by performing, based on the AI model, DRX cycle prediction for the service type set run by the terminal;

sending the second DRX cycle to the network device; and

receiving the first DRX cycle determined by the network device based on the second DRX cycle.

In an embodiment of the present disclosure, the second DRX cycle refers to a cycle determined by, in response to the AI model being deployed on the terminal, the terminal performing, based on the AI model, DRX cycle prediction for the service type set run by the terminal. The word “second” in the second DRX cycle is only used to distinguish it from other DRX cycles and does not specifically refer to a fixed cycle.

Exemplarily, in an embodiment of the present disclosure, the terminal may send the second DRX cycle to the network device. The network device may determine the first DRX cycle based on the second DRX cycle, and the network device may send the first DRX cycle to the terminal.

Exemplarily, in an embodiment of the present disclosure, the terminal may send the second DRX cycle to the network device, and the network device may receive the second DRX cycle.

In an embodiment of the present disclosure, determining the second DRX cycle by performing, based on the AI model, DRX cycle prediction for the service type set run by the terminal, includes:

classifying a service set run by the terminal to determine a service type set of the service set; and

determining the second DRX cycle by performing the DRX cycle prediction based on the AI model corresponding to the service type set.

In an embodiment of the present disclosure, determining the second DRX cycle by performing the DRX cycle prediction based on the AI model corresponding to the service type set includes:

in response to the service type set including one service type, determining the second DRX cycle by performing the DRX cycle prediction based on an AI model corresponding to the one service type.

In an embodiment of the present disclosure, determining the second DRX cycle by performing the DRX cycle prediction based on the AI model corresponding to the service type set includes:

in response to the service type set including at least two service types, determining the second DRX cycle by performing the DRX cycle prediction based on an AI model corresponding to the at least two service types.

Exemplarily, in an embodiment of the present disclosure, determining the second DRX cycle by performing the DRX cycle prediction based on the AI model corresponding to the service type set includes:

in response to the service type set including at least two service types and there being no AI model that corresponds to all the at least two service types, determining at least two fifth DRX cycles corresponding to the at least two service types based on AI models corresponding to the at least two service types, respectively;

determining the second DRX cycle based on the at least two fifth DRX cycles; or,

in response to the service type set including at least two service types and there being no AI model that corresponds to all the at least two service types, performing the DRX cycle prediction without an AI model.

In an embodiment of the present disclosure, the fifth DRX cycle indicates a cycle corresponding to each of the at least two service types determined by the terminal, when the AI model is deployed on the terminal, in response to the service type set including at least two service types and there being no AI model that corresponds to all the at least two service types, based on AI models corresponding to the at least two service types, respectively. There are at least two fifth DRX cycles. The terminal may determine the second DRX cycle based on the at least two fifth DRX cycles.

In an embodiment of the present disclosure, the method further includes:

sending a first model download request for the service set to the network device based on the service set run by the terminal; and

receiving an AI model sent by the network device for the first model download request, in which the AI model corresponds to a service type set of the service set.

In an embodiment of the present disclosure, the method further includes:

in response to a model download instruction for the AI model, sending a second model download request to the network device; and

receiving an AI model sent by the network device for the second model download request.

In an embodiment of the present disclosure, the AI model is a model trained based on a service type corresponding to the AI model.

In summary, in the embodiments of the present disclosure, the first DRX cycle sent by the network device is received, in which the first DRX cycle is determined based on the AI model, and the AI model corresponds to the service type set run by the terminal. In the embodiments of the present disclosure, the first DRX cycle is determined according to the AI that determination of the DRX cycle is inaccurate when different services perform DRX cycle prediction based on a same AI model, and improve the accuracy of the determination of the DRX cycle. The present disclosure provides a processing method for a situation of “determination of a DRX cycle”, so as to receive the DRX cycle determined based on the AI model corresponding to the service type set run by the terminal, which may reduce the situation that the determination of the DRX cycle is inaccurate when different services perform the DRX cycle prediction based on the same AI model, and improve the accuracy of the determination of the DRX cycle.

FIG. 2 is a flowchart of a method for determining a DRX cycle according to the embodiments of the present disclosure. The method is performed by a terminal. As shown in FIG. 2, the method may include the following step 201.

At step 201, in response to the AI model being deployed on the network device, the first DRX cycle determined based on the AI model and sent by the network device is received.

In an embodiment of the present disclosure, the first DRX cycle is determined based on the AI model, and the AI model corresponds to the service type set run by the terminal.

In an embodiment of the present disclosure, the AI model is a model trained based on a service type corresponding to the AI model. For example, the service types may be classified, and different AI models may be used for the DRX cycle prediction for different service types. For example, an AI model corresponding to a video type is different from an AI model corresponding to a text download type. The same AI model may only correspond to one service type, or the same AI model may correspond to at least two service types.

In an embodiment of the present disclosure, for example, when an AI model only corresponds to the video type, the AI model corresponding to the video type may be trained, and the AI model may be used to perform the DRX cycle prediction for a service of the video type. For example, when an AI model only corresponds to a video type and a text download type, the AI model corresponding to both the video type and the text download type may be trained, and the AI model may be used to perform the DRX cycle prediction for services of the video type and the text download type.

In an embodiment of the present disclosure, the AI model may be deployed on the network device. In response to the AI model being deployed on the network device, the terminal may receive the first DRX cycle determined based on the AI model by the network device and sent by the network device. For example, when the network device determines the first DRX cycle based on the AI model, the network device may send the first DRX cycle to the terminal.

In summary, in the embodiments of the present disclosure, in response to the AI model being deployed on the network device, the first DRX cycle determined based on the AI model by the network device and sent by the network device is received. In the embodiments of the present disclosure, the first DRX cycle is determined according to the AI model corresponding to the service type set run by the terminal, which may reduce a situation that determination of the DRX cycle is inaccurate when different services perform DRX cycle prediction based on a same AI model, and improve the accuracy of the determination of the DRX cycle. In the embodiments of the present disclosure, the terminal does not need to set an AI model, which may reduce complexity of model deployment on the terminal side. The present disclosure provides a processing method for a situation of “determination of a DRX cycle”, so as to receive the DRX cycle determined based on the AI model corresponding to the service type set run by the terminal, which may reduce the situation that the determination of the DRX cycle is inaccurate when different services perform the DRX cycle prediction based on the same AI model, and improve the accuracy of the determination of the DRX cycle.

FIG. 3 is a flowchart of a method for determining a DRX cycle according to the embodiments of the present disclosure. The method is performed by a terminal. As shown in FIG. 3, the method may include the following steps 301 to 303.

At step 301, in response to the AI model being deployed on the terminal, a second DRX cycle is determined by performing, based on the AI model, DRX cycle prediction for the service type set run by the terminal.

At step 302, the second DRX cycle is sent to the network device.

At step 303, the first DRX cycle determined based on the second DRX cycle by the network device is received.

In an embodiment of the present disclosure, the AI model is a model trained based on a service type corresponding to the AI model.

In an embodiment of the present disclosure, the first DRX cycle is determined based on the AI model, and the AI model corresponds to the service type set run by the terminal.

In an embodiment of the present disclosure, in response to the AI model being deployed on the terminal, the terminal may determine the second DRX cycle by performing, based on the AI model, the DRX cycle prediction for the service type set run by the terminal. The terminal may send the second DRX cycle to the network device. The network device may receive the second DRX cycle and determine a first DRX cycle based on the second DRX cycle. The network device may send the first DRX cycle determined according to the second DRX cycle to the terminal. The terminal may receive the first DRX cycle determined according to the second DRX cycle by the network device.

Exemplarily, in an embodiment of the present disclosure, the second DRX cycle determined by the terminal may also be a DRX cycle determined by the terminal based on its power and a service set operated by the terminal.

Exemplarily, in an embodiment of the present disclosure, the first DRX cycle may, for example, be a DRX cycle obtained by adjusting the second DRX cycle by the network device. For example, the network device may obtain the first DRX cycle by adjusting the second DRX cycle using downlink control information (DCI) or upper-layer information.

In summary, in the embodiments of the present disclosure, in response to the AI model being deployed on the terminal, the second DRX cycle is determined by performing, based on the AI model, DRX cycle prediction for the service type set run by the terminal; the second DRX cycle is sent to the network device; and the first DRX cycle determined based on the second DRX cycle by the network device is received. In the embodiments of the present disclosure, the first DRX cycle is determined according to the AI model corresponding to the service type set run by the terminal, which may reduce a situation that determination of the DRX cycle is inaccurate when different services perform DRX cycle prediction based on a same AI model, and improve the accuracy of the determination of the DRX cycle. The embodiments of the present disclosure specifically disclose a solution that the first DRX cycle is determined according to the second DRX cycle. The present disclosure provides a processing method for a situation of “determination of a DRX cycle”, so as to receive the DRX cycle determined based on the AI model corresponding to the service type set run by the terminal, which may reduce the situation that the determination of the DRX cycle is inaccurate when different services perform the DRX cycle prediction based on the same AI model, and improve the accuracy of the determination of the DRX cycle.

FIG. 4 is a flowchart of a method for determining a DRX cycle according to the embodiments of the present disclosure. The method is performed by a terminal. As shown in FIG. 4, the method may include the following steps 401 to 402.

At step 401, a service set run by the terminal is classified to determine a service type set of the service set.

At step 402, the second DRX cycle is determined by performing the DRX cycle prediction based on the AI model corresponding to the service type set.

In an embodiment of the present disclosure, the AI model is a model trained based on the service type corresponding to the AI model.

Exemplarily, in an embodiment of the present disclosure, the service set may refer to a set that includes at least one running service. The service set does not refer to a fixed set. For example, when the number of services running on the terminal changes, the service set may also change accordingly. For example, when a specific service running on the terminal changes, the service set may also change accordingly.

Exemplarily, in an embodiment of the present disclosure, the service type set refers to a type set corresponding to the service set. The service type set, for example, may refer to a set that includes at least one service type.

Exemplarily, in an embodiment of the present disclosure, in response to the AI model being deployed on the terminal, the terminal may determine the service set run by the terminal. The terminal may classify the service set to determine the service type set of the service set. The terminal may determine the second DRX cycle by performing the DRX cycle prediction based on the AI model corresponding to the service type set. The number of services corresponding to the service set may not be the same as the number of the service types corresponding to the service type set. For example, if the service set contains two services of a same service type, the number of services corresponding to the service set is different from the number of the service types corresponding to the service type set.

In summary, in the embodiments of the present disclosure, the service set run by the terminal is classified to determine the service type set of the service set; and the second DRX cycle is determined by performing the DRX cycle prediction based on the AI model corresponding to the service type set. In the embodiments of the present disclosure, the second DRX cycle is determined according to the AI model corresponding to the service type set run by the terminal, which may reduce a situation that determination of the DRX cycle is inaccurate when different services in the terminal perform DRX cycle prediction based on a same AI model, and improve the accuracy of the determination of the DRX cycle. The embodiments of the present disclosure specifically disclose a solution for determining the second DRX cycle. The present disclosure provides a processing method for a situation of “determination of a DRX cycle”, so as to determine the DRX cycle based on the AI model corresponding to the service type set run by the terminal, which may reduce a situation that determination of the DRX cycle is inaccurate when different services perform DRX cycle prediction based on a same AI model, and improve the accuracy of the determination of the DRX cycle.

FIG. 5 is a flowchart of a method for determining a DRX cycle according to the embodiments of the present disclosure. The method is performed by a terminal. As shown in FIG. 5, the method may include the following step 501.

At step 501, in response to the service type set including one service type, the second DRX cycle is determined by performing the DRX cycle prediction based on an AI model corresponding to the one service type.

In an embodiment of the present disclosure, the AI model is a model trained based on the service type corresponding to the AI model.

In an embodiment of the present disclosure, in response to the service type set including one service type, the terminal may determine the second DRX cycle by performing the DRX cycle prediction based on the AI model corresponding to the one service type.

Exemplarily, in an embodiment of the present disclosure, in response to the service type set including one service type, the one service type may, for example, be a video type. The terminal may determine the second DRX cycle by performing the DRX cycle prediction based on the AI model corresponding to the video type.

In summary, in the embodiments of the present disclosure, in response to the service type set including one service type, the second DRX cycle is determined by performing the DRX cycle prediction based on an AI model corresponding to the one service type. In the embodiments of the present disclosure, the second DRX cycle is determined according to the AI that determination of the DRX cycle is inaccurate when different services perform DRX cycle prediction based on a same AI model, and improve the accuracy of the determination of the DRX cycle. The embodiments of the present disclosure specifically disclose a solution for determining the second DRX cycle when the service type set includes one service type. The present disclosure provides a processing method for a situation of “determination of a DRX cycle”, so as to determine the DRX cycle based on the AI model corresponding to the service type set run by the terminal, which may reduce the situation that the determination of the DRX cycle is inaccurate when different services perform the DRX cycle prediction based on the same AI model, and improve the accuracy of the determination of the DRX cycle.

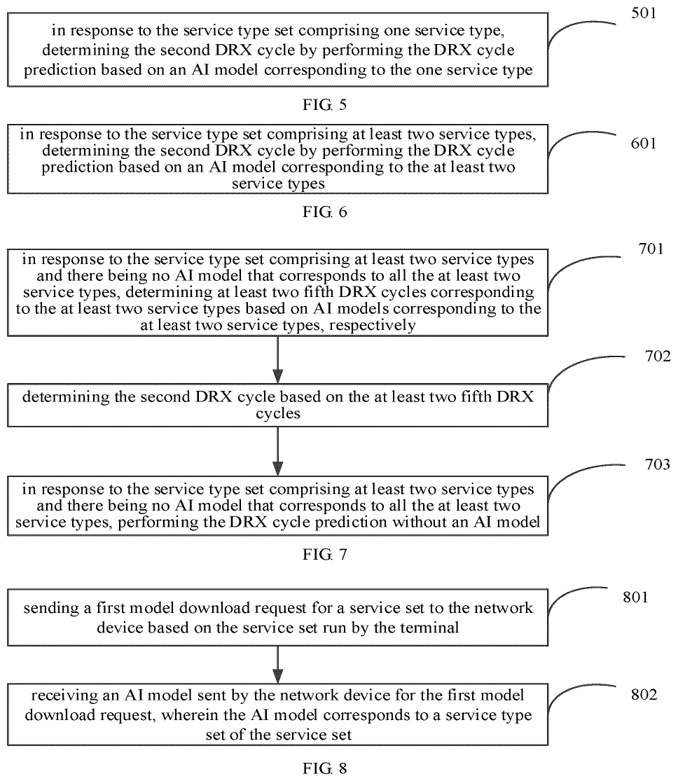

FIG. 6 is a flowchart of a method for determining a DRX cycle according to the embodiments of the present disclosure. The method is performed by a terminal. As shown in FIG. 6, the method may include the following step 601.

At step 601, in response to the service type set including at least two service types, the second DRX cycle is determined by performing the DRX cycle prediction based on an AI model corresponding to the at least two service types.

In an embodiment of the present disclosure, the AI model is a model trained based on the service type corresponding to the AI model. The AI model in the embodiments of the present disclosure is a model trained based on the at least two service types corresponding to the AI model.

In an embodiment of the present disclosure, in response to the service type set including the at least two service types, the terminal may determine the second DRX cycle by performing the DRX cycle prediction based on the AI model corresponding to the at least two service types. The AI model corresponds to all of the at least two service types. For example, the AI model is a model trained based on the at least two service types corresponding to the AI model.

Exemplarily, in an embodiment of the present disclosure, in response to the service type set including the at least two service types, such as a video type and a text download type, the terminal may determine the second DRX cycle by performing the DRX cycle prediction based on an AI model corresponding to both the video type and the text download type.

In summary, in the embodiments of the present disclosure, in response to the service type set including the at least two service types, the second DRX cycle is determined by performing the DRX cycle prediction based on the AI model corresponding to the at least two service types. In the embodiments of the present disclosure, the second DRX cycle is determined according to the AI model corresponding to the service type set run by the terminal, which may reduce a situation that determination of the DRX cycle is inaccurate when different services perform DRX cycle prediction based on a same AI model, and improve the accuracy of the determination of the DRX cycle. The embodiments of the present disclosure specifically disclose a solution for determining the second DRX cycle when the service type set includes the at least two service types. The present disclosure provides a processing method for a situation of “determination of a DRX cycle”, so as to determine the DRX cycle based on the AI model corresponding to the service type set run by the terminal, which may reduce the situation that the determination of the DRX cycle is inaccurate when different services perform the DRX cycle prediction based on the same AI model, and improve the accuracy of the determination of the DRX cycle.

FIG. 7 is a flowchart of a method for determining a DRX cycle according to the embodiments of the present disclosure. The method is performed by a terminal. As shown in FIG. 7, the method may include the following steps 701 to 703.

At step 701, in response to the service type set including at least two service types and there being no AI model that corresponds to all the at least two service types, at least two fifth DRX cycles corresponding to the at least two service types are determined based on AI models corresponding to the at least two service types, respectively.

At step 702, the second DRX cycle is determined based on the at least two fifth DRX cycles.

At step 703, in response to the service type set including at least two service types and there being no AI model that corresponds to all the at least two service types, the DRX cycle prediction is performed without an AI model.

In an embodiment of the present disclosure, the steps 701 to 702 or the step 703 is executed optionally, that is, the step 703 is not executed when the steps 701 to 702 are executed, and the steps 701 to 702 are not executed when the step 703 is executed.

In an embodiment of the present disclosure, the AI model is a model trained based on the service type corresponding to the AI model.

In an embodiment of the present disclosure, in response to the service type set including the at least two service types and there being no AI model that corresponds to all the at least two service types, the terminal may determine at least two fifth DRX cycles corresponding to the at least two service types based on AI models corresponding to the at least two service types, respectively; and determine the second DRX cycle based on the at least two fifth DRX cycles.

Exemplarily, in an embodiment of the present disclosure, in response to the service type set including the at least two service types, in which the at least two service types are, for example, a video type and a text download type, and there being no AI model that corresponds to both the video type and the text download type, the terminal may determine a fifth DRX cycle corresponding to the video type based on an AI model corresponding to the video type, and determine a fifth DRX cycle corresponding to the text download type based on an AI model corresponding to the text download type. The terminal may determine the second DRX cycle based on the fifth DRX cycle corresponding to the video type and the fifth DRX cycle corresponding to the text download type.

In an embodiment of the present disclosure, in response to the service type set including at least two service types and there being no AI model that corresponds to all the at least two service types, the terminal may perform the DRX cycle prediction without an AI model.

Exemplarily, in an embodiment of the present disclosure, in response to the service type set including at least two service types, in which the at least two service types are, for example, a video type and a text download type, and there being no AI model that corresponds to both the video type and the text download type, the terminal may perform the DRX cycle prediction without an AI model.

In summary, in the embodiments of the present disclosure, in response to the service type set including the at least two service types and there being no AI model that corresponds to all the at least two service types, at least two fifth DRX cycles corresponding to the at least two service types are determined based on AI models corresponding to the at least two service types, respectively; the second DRX cycle is determined based on the at least two fifth DRX cycles; or in response to the service type set including at least two service types and there being no AI model that corresponds to all the at least two service types, the DRX cycle prediction is performed without the AI model. In the embodiments of the present disclosure, the second DRX cycle is determined according to the AI model corresponding to the service type set run by the terminal, which may reduce a situation that determination of the DRX cycle is inaccurate when different services perform DRX cycle prediction based on a same AI model, and improve the accuracy of the determination of the DRX cycle. The embodiments of the present disclosure specifically disclose a solution for determining the second DRX cycle when the service type set includes at least two service types and there is no AI model that corresponds to all the at least two service types. The present disclosure provides a processing method for a situation of “determination of a DRX cycle”, so as to determine the DRX cycle based on the AI model corresponding to the service type set run by the terminal, which may reduce the situation that the determination of the DRX cycle is inaccurate when different services perform the DRX cycle prediction based on the same AI model, and improve the accuracy of the determination of the DRX cycle.

FIG. 8 is a flowchart of a method for determining a DRX cycle according to the embodiments of the present disclosure. The method is performed by a terminal. As shown in FIG. 8, the method may include the following steps 801 to 802.

At step 801, a first model download request for a service set is sent to the network device based on the service set run by the terminal.

At step 802, an AI model sent by the network device for the first model download request is received, in which the AI model corresponds to a service type set of the service set.

In an embodiment of the present disclosure, the AI model is a model trained based on the service type corresponding to the AI model.

In an embodiment of the present disclosure, the first model download request refers to a request sent by the terminal based on the service set run by the terminal. The word “first” in the first model download request is only used to distinguish it from other model download requests and does not specifically refer to a fixed model download request.

Exemplarily, in an embodiment of the present disclosure, the terminal may send the first model download request for the service set to the network device based on the service set run by the terminal. The terminal may receive the AI model sent by the network device for the first model download request, in which the AI model corresponds to the service type set of the service set.

Exemplarily, in an embodiment of the present disclosure, the service set run by the terminal may include, for example, a video playback service. Based on the video playback service run by the terminal, the terminal may send the first model download request for the video playback service to the network device. The terminal may receive the AI model sent by the network device for the first model download request, in which the AI model corresponds to a video type of the video playback service.

In summary, in the embodiments of the present disclosure, the first model download request for the service set is sent to the network device based on the service set run by the terminal; and the AI model sent by the network device for the first model download request is received, in which the AI model corresponds to the service type set of the service set. In the embodiments of the present disclosure, the terminal may send the model download request to the network device, and different model download requests may be sent to the network device according to different download situations, which may improve the convenience of AI model downloading. At the same time, the terminal may receive the AI model sent by the network device for the first model download request, and the AI model corresponds to the service type set of the service set, which may improve a match between the AI model and the service set.

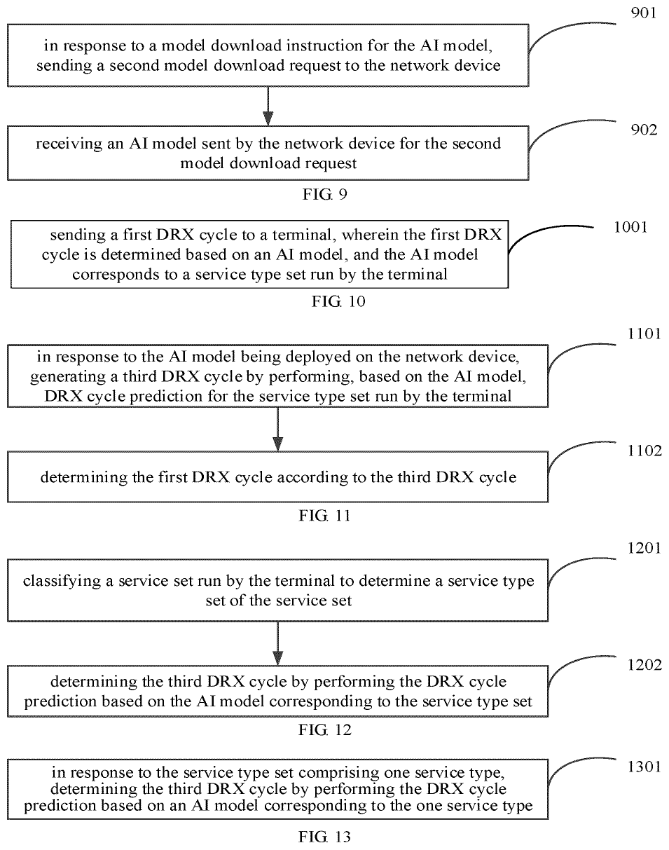

FIG. 9 is a flowchart of a method for determining a DRX cycle according to the embodiments of the present disclosure. The method is performed by a terminal. As shown in FIG. 9, the method may include the following steps 901 to 902.

At step 901, in response to a model download instruction for the AI model, a second model download request is sent to the network device.

At step 902, an AI model sent by the network device for the second model download request is received.

In an embodiment of the present disclosure, the AI model is a model trained based on the service type corresponding to the AI model.

Exemplarily, in an embodiment of the present disclosure, when the terminal sends the first model download request for the service set to the network device based on the service set run by the terminal, the terminal may monitor the service run by the terminal and send the first model download request to the network device based on a monitoring result.

In an embodiment of the present disclosure, the second model download request is a request sent by the terminal for the model download instruction of the AI model. The word “second” in the second model download request is used only to distinguish it from other model download requests and does not specifically refer to a fixed model download request.

Exemplarily, in an embodiment of the present disclosure, the service set run by the terminal may include, for example, a game service, and, based on the game service run by the terminal, the terminal may send the first model download request for the game service to the network device. The terminal may receive the AI model sent by the network device for the first model download request, in which the AI model corresponds to a video type of the game service.

Exemplarily, in an embodiment of the present disclosure, the terminal may send the second model download request to the network device in response to the model download instruction for the AI model. The terminal may receive the AI model sent by the network device for the second model download request.

In summary, in the embodiments of the present disclosure, in response to the model download instruction for the AI model, the second model download request is sent to the network device; and the AI model sent by the network device for the second model download request is received. In the embodiments of the present disclosure, the terminal may send the model download request to the network device in response to the model download instruction for the AI model, which may improve the convenience of AI model downloading, reduce a mismatch between the AI model and the service set, and improve a match between the AI model and the service set.

FIG. 10 is a flowchart of a method for determining a DRX cycle according to the embodiments of the present disclosure. The method is performed by a network device. As shown in FIG. 10, the method may include the following step 1001.

At step 1001, a first DRX cycle is sent to a terminal, in which the first DRX cycle is determined based on an AI model, and the AI model corresponds to a service type set run by the terminal.

In an embodiment of the present disclosure, before sending the first DRX cycle to the terminal, the method further includes:

in response to the AI model being deployed on the network device, generating a third DRX cycle by performing, based on the AI model, DRX cycle prediction for the service type set run by the terminal; and determining the first DRX cycle according to the third DRX cycle.

In an embodiment of the present disclosure, determining the third DRX cycle by performing, based on the AI model, DRX cycle prediction for the service type set run by the terminal, includes:

classifying a service set run by the terminal to determine a service type set of the service set; and

determining the third DRX cycle by performing the DRX cycle prediction based on the AI model corresponding to the service type set.

Exemplarily, in an embodiment of the present disclosure, determining the third DRX cycle by performing the DRX cycle prediction based on the AI model corresponding to the service type set includes:

in response to the service type set including one service type, determining the third DRX cycle by performing the DRX cycle prediction based on an AI model corresponding to the one service type.

In an embodiment of the present disclosure, determining the third DRX cycle by performing the DRX cycle prediction based on the AI model corresponding to the service type set includes:

in response to the service type set including at least two service types, determining the third DRX cycle by performing the DRX cycle prediction based on an AI model corresponding to the at least two service types.

Exemplarily, in an embodiment of the present disclosure, determining the third DRX cycle by performing the DRX cycle prediction based on the AI model corresponding to the service type set includes:

in response to the service type set including at least two service types and there being no AI model that corresponds to all the at least two service types, determining at least two fourth DRX cycles corresponding to the at least two service types based on AI models corresponding to the at least two service types, respectively;

determining the third DRX cycle based on the at least two fourth DRX cycles; or,

in response to the service type set including at least two service types and there being no AI model that corresponds to all the at least two service types, performing the DRX cycle prediction without an AI model.

Exemplarily, in an embodiment of the present disclosure, before sending the first DRX cycle to the terminal, the method further includes:

in response to the AI model being deployed on the terminal, receiving a second DRX cycle determined by the terminal based on the AI model and sent by the terminal; and

determining the first DRX cycle according to the second DRX cycle.

Further, in an embodiment of the present disclosure, the method further includes:

receiving a first model download request sent by the terminal, in which the first model download request is a request for a service set run by the terminal; and

sending an AI model for the first model download request to the terminal, in which the AI model corresponds to a service type set of the service set.

Further, in an embodiment of the present disclosure, the method further includes:

receiving a second model download request sent by the terminal for a model download instruction of the AI model; and

sending the AI model for the second model download request to the terminal.

Exemplarily, in an embodiment of the present disclosure, the AI model is a model trained based on a service type corresponding to the AI model.

Exemplarily, in an embodiment of the present disclosure, input data of the AI model may be, for example, an arrival interval of pervious N data packets, and output data of the AI model may be, for example, an arrival interval of subsequent M data packets, in which N and M are positive integers.

Exemplarily, in an embodiment of the present disclosure, values of N and M may be different for different service types or for different AI models. In other words, for different service types, trained AI models may be different.

In summary, in the embodiments of the present disclosure, the first DRX cycle is sent to the terminal, in which the first DRX cycle is determined based on the AI model, and the AI model corresponds to the service type set run by the terminal. In the embodiments of the present disclosure, the first DRX cycle is determined according to the AI model corresponding to the service type set run by the terminal, which may reduce a situation that determination of the DRX cycle is inaccurate when different services perform DRX cycle prediction based on a same AI model, and improve the accuracy of the determination of the DRX cycle. The present disclosure provides a processing method for a situation of “determination of a DRX cycle”, so as to send the DRX cycle determined based on the AI model corresponding to the service type set run by the terminal to the terminal, which may reduce the situation that the determination of the DRX cycle is inaccurate when different services perform the DRX cycle prediction based on the same AI model, and improve the accuracy of the determination of the DRX cycle.

FIG. 11 is a flowchart of a method for determining a DRX cycle according to the embodiments of the present disclosure. The method is performed by a network device. As shown in FIG. 11, the method may include the following steps 1101 to 1102.

At step 1101, in response to the AI model being deployed on the network device, a third DRX cycle is generated by performing, based on the AI model, DRX cycle prediction for the service type set run by the terminal.

At step 1102, the first DRX cycle is determined according to the third DRX cycle.

In an embodiment of the present disclosure, the AI model is a model trained based on the service type corresponding to the AI model.

In an embodiment of the present disclosure, the third DRX cycle is a DRX cycle generated by performing, based on the AI model, DRX cycle prediction for the service type set run by the terminal. The “third” in the third DRX cycle is only used to distinguish it from other DRX cycles and does not specifically refer to a fixed DRX cycle.

Exemplarily, in an embodiment of the present disclosure, in response to the AI model being deployed on the network device, the network device may generate the third DRX cycle by performing, based on the AI model, DRX cycle prediction for the service type set run by the terminal; and determines the first DRX cycle according to the third DRX cycle.

In an embodiment of the present disclosure, the network device may send the first DRX cycle to the terminal.

Exemplarily, in an embodiment of the present disclosure, when the network device may determine the first DRX cycle according to the third DRX cycle, the network device may determine the first DRX cycle by adjusting the third DRX cycle via DCI or upper-layer information.

In an embodiment of the present disclosure, for different terminals, the network side may perform, based on different AI models, DRX cycle prediction for the service type set run by the terminal. The AI models used by the network device may be determined, for example, based on a usage behavior of the terminal.

Exemplarily, in an embodiment of the present disclosure, there may be one or more AI models deployed by the network device.

In summary, in the embodiments of the present disclosure, in response to the AI model being deployed on the network device, the third DRX cycle is generated by performing, based on the AI model, DRX cycle prediction for the service type set run by the terminal; and the first DRX cycle is determined according to the third DRX cycle. In the embodiments of the present disclosure, the first DRX cycle is determined according to the AI model corresponding to the service type set run by the terminal, which may reduce a situation that determination of the DRX cycle is inaccurate when different services perform DRX cycle prediction based on a same AI model, and improve the accuracy of the determination of the DRX cycle. The embodiments of the present disclosure specifically disclose a solution that the first DRX cycle is determined according to the third DRX cycle. The present disclosure provides a processing method for a situation of “determination of a DRX cycle”, so as to determine the DRX cycle based on the AI model corresponding to the service type set run by the terminal, which may reduce the situation that the determination of the DRX cycle is inaccurate when different services perform the DRX cycle prediction based on the same AI model, and improve the accuracy of the determination of the DRX cycle.

FIG. 12 is a flowchart of a method for determining a DRX cycle according to the embodiments of the present disclosure. The method is performed by a network device. As shown in FIG. 12, the method may include the following steps 1201 to 1202.

At step 1201, a service set run by the terminal is classified to determine a service type set of the service set.

At step 1202, the third DRX cycle is determined by performing the DRX cycle prediction based on the AI model corresponding to the service type set.

In an embodiment of the present disclosure, the AI model is a model trained based on the service type corresponding to the AI model.

Exemplarily, in an embodiment of the present disclosure, the service set may refer to a set that includes at least one running service. The service set does not refer to a fixed set. For example, when the number of services running on the terminal changes, the service set may also change accordingly. For example, when a specific service running on the terminal changes, the service set may also change accordingly.

Exemplarily, in an embodiment of the present disclosure, the service type set refers to a type set corresponding to the service set. The service type set, for example, may refer to a set that includes at least one service type.

Exemplarily, in an embodiment of the present disclosure, in response to the AI model being deployed on the terminal, the network device may determine a service set running on the terminal. For example, the network device may receive the service set sent by the terminal. For another example, the network device may determine the service set running on the terminal based on communication data between the terminal and the network device.

Exemplarily, in an embodiment of the present disclosure, the network device may classify the service set run by the terminal to determine the service type set of the service set; and determine the third DRX cycle by performing the DRX cycle prediction based on the AI model corresponding to the service type set. The number of services corresponding to the service set is not necessarily equal to the number of service types corresponding to the service type set. For example, when there are two services of a same service type in the service set, the number of services corresponding to the service set is not equal to the number of service types corresponding to the service type set.

In summary, in the embodiments of the present disclosure, the service set run by the terminal is classified to determine the service type set of the service set; and the third DRX cycle is determined by performing the DRX cycle prediction based on the AI model corresponding to the service type set. In the embodiments of the present disclosure, the third DRX cycle is determined according to the AI model corresponding to the service type set run by the terminal, which may reduce a situation that determination of the DRX cycle is inaccurate when different services in the network device perform DRX cycle prediction based on a same AI model, and improve the accuracy of the determination of the DRX cycle. The embodiments of the present disclosure specifically disclose a solution for determining the third DRX cycle. The present disclosure provides a processing method for a situation of “determination of a DRX cycle”, so as to determine the DRX cycle based on the AI model corresponding to the service type set run by the terminal, which may reduce the situation that the determination of the DRX cycle is inaccurate when different services perform the DRX cycle prediction based on the same AI model, and improve the accuracy of the determination of the DRX cycle.

FIG. 13 is a flowchart of a method for determining a DRX cycle according to the embodiments of the present disclosure. The method is performed by a network device. As shown in FIG. 13, the method may include the following step 1301.

At step 1301, in response to the service type set including one service type, the third DRX cycle is determined by performing the DRX cycle prediction based on an AI model corresponding to the one service type.

In an embodiment of the present disclosure, the AI model is a model trained based on the service type corresponding to the AI model.

In an embodiment of the present disclosure, in response to the service type set including one service type, the network device may determine the third DRX cycle by performing the DRX cycle prediction based on the AI model corresponding to the one service type.

Exemplarily, in an embodiment of the present disclosure, in response to the service type set including one service type, the one service type may, for example, be a video type. The network device may determine the third DRX cycle by performing the DRX cycle prediction based on the AI model corresponding to the video type.

In summary, in the embodiments of the present disclosure, in response to the service type set including one service type, the third DRX cycle is determined by performing the DRX cycle prediction based on the AI model corresponding to the one service type. In the embodiments of the present disclosure, the third DRX cycle is determined according to the AI that determination of the DRX cycle is inaccurate when different services in the network device perform DRX cycle prediction based on a same AI model, and improve the accuracy of the determination of the DRX cycle. The embodiments of the present disclosure specifically disclose a solution for determining the third DRX cycle when the service type set includes one service type. The present disclosure provides a processing method for a situation of “determination of a DRX cycle”, so as to determine the DRX cycle based on the AI model corresponding to the service type set run by the terminal, which may reduce the situation that the determination of the DRX cycle is inaccurate when different services perform the DRX cycle prediction based on the same AI model, and improve the accuracy of the determination of the DRX cycle.

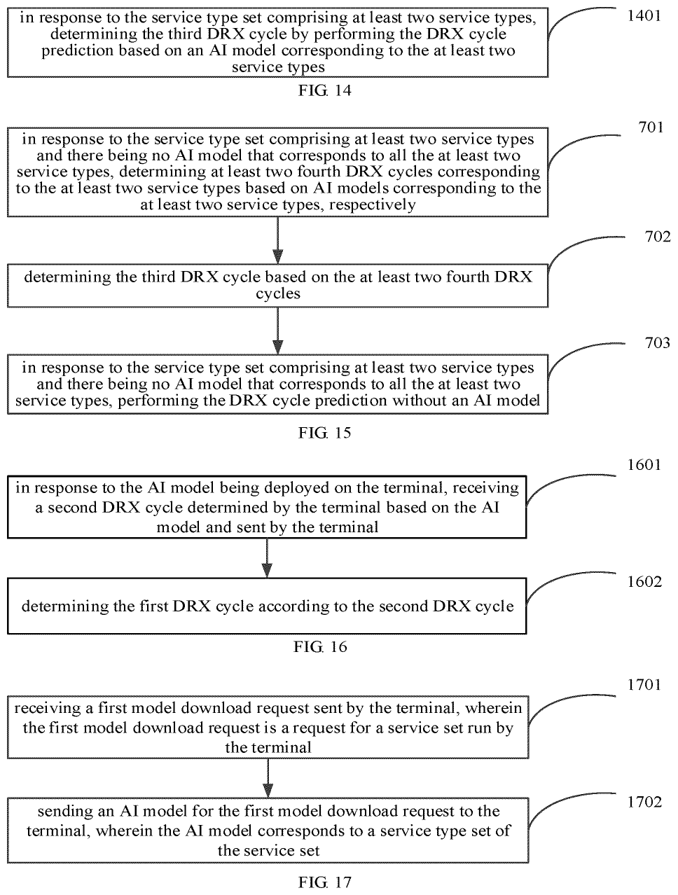

FIG. 14 is a flowchart of a method for determining a DRX cycle according to the embodiments of the present disclosure. The method is performed by a network device. As shown in FIG. 14, the method may include the following step 1401.

At step 1401, in response to the service type set including at least two service types, the third DRX cycle is determined by performing the DRX cycle prediction based on an AI model corresponding to the at least two service types.

In an embodiment of the present disclosure, the AI model is a model trained based on the service type corresponding to the AI model.

In an embodiment of the present disclosure, in response to the service type set including the at least two service types, the network device may determine the third DRX cycle by performing the DRX cycle prediction based on the AI model corresponding to the at least two service types. The AI model corresponds to the at least two service types simultaneously. For example, the AI model is a model trained based on the at least two service types corresponding to the AI model.

Exemplarily, in an embodiment of the present disclosure, in response to the service type set including the at least two service types, such as a video type and a text download type, the network device may determine the third DRX cycle by performing the DRX cycle prediction based on an AI model corresponding to both the video type and the text download type.

In summary, in the embodiments of the present disclosure, in response to the service type set including the at least two service types, the third DRX cycle is determined by performing the DRX cycle prediction based on the AI model corresponding to the at least two service types. In the embodiments of the present disclosure, the third DRX cycle is determined according to the AI model corresponding to the service type set run by the terminal, which may reduce a situation that determination of the DRX cycle is inaccurate when different services in the network device perform DRX cycle prediction based on a same AI model, and improve the accuracy of the determination of the DRX cycle. The embodiments of the present disclosure specifically disclose a solution for determining the third DRX cycle when the service type set includes the at least two service types. The present disclosure provides a processing method for a situation of “determination of a DRX cycle”, so as to determine the DRX cycle based on the AI model corresponding to the service type set run by the terminal, which may reduce the situation that the determination of the DRX cycle is inaccurate when different services perform the DRX cycle prediction based on the same AI model, and improve the accuracy of the determination of the DRX cycle.

FIG. 15 is a flowchart of a method for determining a DRX cycle according to the embodiments of the present disclosure. The method is performed by a network device. As shown in FIG. 15, the method may include the following steps 1501 to 1503.

At step 1501, in response to the service type set including at least two service types and there being no AI model that corresponds to all the at least two service types, at least two fourth DRX cycles corresponding to the at least two service types are determined based on AI models corresponding to the at least two service types, respectively.

At step 1502, the third DRX cycle is determined based on the at least two fourth DRX cycles.

Or,

at step 1503, in response to the service type set including at least two service types and there being no AI model that corresponds to all the at least two service types, the DRX cycle prediction is performed without an AI model.

In an embodiment of the present disclosure, the AI model is a model trained based on the service type corresponding to the AI model.

In an embodiment of the present disclosure, the steps 1501 to 1502 or the step 1503 is executed optionally, that is, the step 1503 is not executed when the steps 1501 to 1502 are executed, and the steps 1501 to 1502 are not executed when the step 1503 is executed.

In an embodiment of the present disclosure, the fourth DRX cycle indicates a cycle corresponding to each of the at least two service types determined by the network device, when the AI model is deployed on the network device, in response to the service type set including at least two service types and there being no AI model that corresponds to all the at least two service types, the network device determines at least two fourth DRX cycles based on AI models corresponding to the at least two service types, respectively. There may be at least two fourth DRX cycles.

In an embodiment of the present disclosure, in response to the service type set including the at least two service types and there being no AI model that corresponds to all the at least two service types, the network device may determine at least two fourth DRX cycles corresponding to the at least two service types based on AI models corresponding to the at least two service types, respectively; and determine the third DRX cycle based on the at least two fourth DRX cycles.

Exemplarily, in an embodiment of the present disclosure, in response to the service type set including the at least two service types, in which the at least two service types are, for example, a video type and a text download type, in response to the AI model being deployed on the network device and there being no AI model that corresponds to all the video type and the text download type, the network device may determine a fourth DRX cycle corresponding to the video type based on an AI model corresponding to the video type, and determine a fourth DRX cycle corresponding to the text download type based on an AI model corresponding to the text download type. The network device may determine the third DRX cycle based on the fourth DRX cycle corresponding to the video type and the fourth DRX cycle corresponding to the text download type.

In an embodiment of the present disclosure, in response to the service type set including the at least two service types and there being no AI model that corresponds to all the at least two service types, the network device may perform the DRX cycle prediction without an AI model.

Exemplarily, in an embodiment of the present disclosure, in response to the service type set including the at least two service types, in which the at least two service types are, for example, a video type and a text download type, and there being no AI model that corresponds to all the video type and the text download type in the network device, the network device may perform the DRX cycle prediction without the AI model.

In summary, in the embodiments of the present disclosure, in response to the service type set including the at least two service types and there being no AI model that corresponds to all the at least two service types, the at least two fourth DRX cycles corresponding to the at least two service types are determined based on AI models corresponding to the at least two service types, respectively; the third DRX cycle is determined based on the at least two fourth DRX cycles; or, in response to the service type set including the at least two service types and there being no AI model that corresponds to all the at least two service types, the DRX cycle prediction is performed without the AI model. In the embodiments of the present disclosure, the third DRX cycle is determined according to the AI model corresponding to the service type set run by the terminal, which may reduce a situation that determination of the DRX cycle is inaccurate when different services in the network device perform DRX cycle prediction based on a same AI model, and improve the accuracy of the determination of the DRX cycle. The embodiments of the present disclosure specifically disclose a solution for determining the third DRX cycle when the service type set includes the at least two service types. The present disclosure provides a processing method for a situation of “determination of a DRX cycle”, so as to determine the DRX cycle based on the AI model corresponding to the service type set run by the terminal, which may reduce the situation that the determination of the DRX cycle is inaccurate when different services perform the DRX cycle prediction based on the same AI model, and improve the accuracy of the determination of the DRX cycle.

FIG. 16 is a flowchart of a method for determining a DRX cycle according to the embodiments of the present disclosure. The method is performed by a network device. As shown in FIG. 16, the method may include the following steps 1601 to 1602.

At step 1601, in response to the AI model being deployed on the terminal, a second DRX cycle determined by the terminal based on the AI model and sent by the terminal is received.

At step 1602, the first DRX cycle is determined according to the second DRX cycle.

In an embodiment of the present disclosure, the AI model is a model trained based on the service type corresponding to the AI model.

For a detailed description of steps 1601 to 1602, reference may be made to a description of the above embodiments, which will not be repeated herein.

Exemplarily, in an embodiment of the present disclosure, when the network device determines the first DRX cycle according to the second DRX cycle, the network device may send the first DRX cycle to the terminal.

In summary, in the embodiments of the present disclosure, in response to the AI model being deployed on the terminal, the second DRX cycle determined by the terminal based on the AI model and sent by the terminal is received; and the first DRX cycle is determined according to the second DRX cycle. In the embodiments of the present disclosure, the first DRX cycle is determined according to the AI model corresponding to the service type set run by the terminal, which may reduce a situation that determination of the DRX cycle is inaccurate when different services in the network device perform DRX cycle prediction based on a same AI model, and improve the accuracy of the determination of the DRX cycle. The embodiments of the present disclosure specifically disclose a solution that the first DRX cycle is determined according to the second DRX cycle sent by the terminal. The present disclosure provides a processing method for a situation of “determination of a DRX cycle”, so as to determine the DRX cycle based on the AI model corresponding to the service type set run by the terminal, which may reduce the situation that the determination of the DRX cycle is inaccurate when different services perform the DRX cycle prediction based on the same AI model, and improve the accuracy of the determination of the DRX cycle.

FIG. 17 is a flowchart of a method for determining a DRX cycle according to the embodiments of the present disclosure. The method is performed by a network device. As shown in FIG. 17, the method may include the following steps 1701 to 1702.

At step 1701, a first model download request sent by the terminal is received, in which the first model download request is a request for a service set run by the terminal.

At step 1702, an AI model for the first model download request is sent to the terminal, in which the AI model corresponds to a service type set of the service set.

In an embodiment of the present disclosure, the AI model is a model trained based on the service type corresponding to the AI model.

For a detailed description of steps 1701 to 1702, reference may be made to a description of the above embodiments, which will not be repeated herein.

In summary, in the embodiments of the present disclosure, the first model download request sent by the terminal is received, in which the first model download request is the request for the service set run by the terminal; and the AI model for the first model download request is sent to the terminal, in which the AI model corresponds to the service type set of the service set. In the embodiments of the present disclosure, the network device may receive the model download request sent by the terminal, and different download conditions may correspond to different model download requests, which may improve the convenience of AI model downloading. At the same time, the network device may send the AI model for the first model download request to the terminal, and the AI model corresponds to the service type set of the service set, which may improve a match between the AI model and the service set.

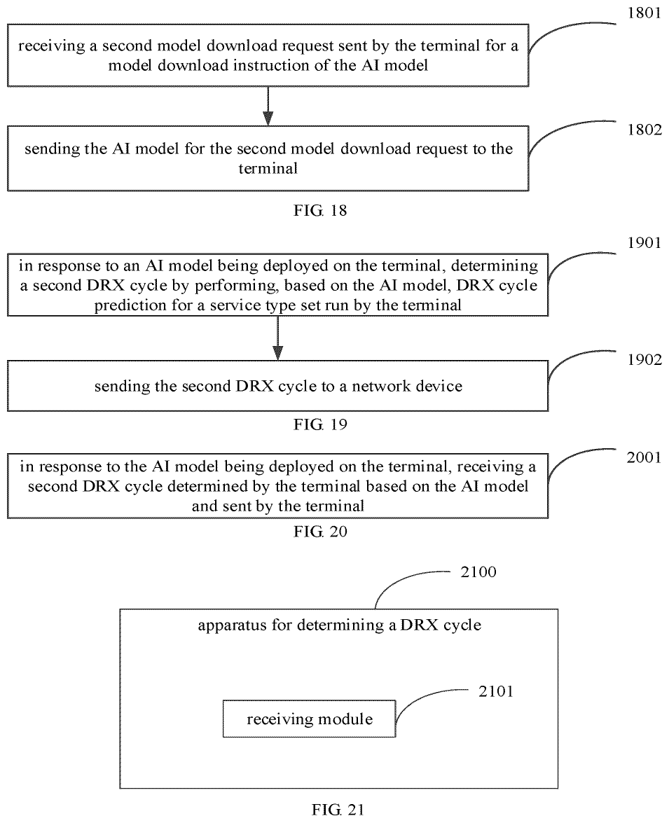

FIG. 18 is a flowchart of a method for determining a DRX cycle according to the embodiments of the present disclosure. The method is performed by a network device. As shown in FIG. 18, the method may include the following steps 1801 to 1802.

At step 1801, a second model download request sent by the terminal for a model download instruction of the AI model is received.

At step 1802, the AI model for the second model download request is sent to the terminal.

In an embodiment of the present disclosure, the AI model is a model trained based on the service type corresponding to the AI model.

For a detailed description of steps 1801 to 1802, reference may be made to a description of the above embodiments, which will not be repeated herein.

In summary, in the embodiments of the present disclosure, the second model download request sent by the terminal for the model download instruction of the AI model is received; and the AI model for the second model download request is sent to the terminal. In the embodiments of the present disclosure, the network device may receive the model download request sent by the terminal for the model download instruction of the AI model, which may improve the convenience of AI model downloading, reduce a mismatch between the AI model and the service set, and improve a match between the AI model and the service set.

FIG. 19 is a flowchart of a method for determining a DRX cycle according to the embodiments of the present disclosure. The method is performed by a terminal. As shown in FIG. 19, the method may include the following steps 1901 to 1902.

At step 1901, in response to an AI model being deployed on the terminal, a second DRX cycle is determined by performing, based on the AI model, DRX cycle prediction for a service type set run by the terminal.

At step 1902, the second DRX cycle is sent to a network device.

In an embodiment of the present disclosure, determining the second DRX cycle by performing, based on the AI model, DRX cycle prediction for the service type set run by the terminal, includes:

classifying a service set run by the terminal to determine a service type set of the service set; and

determining the second DRX cycle by performing the DRX cycle prediction based on the AI model corresponding to the service type set.

In an embodiment of the present disclosure, determining the second DRX cycle by performing the DRX cycle prediction based on the AI model corresponding to the service type set includes:

in response to the service type set including one service type, determining the second DRX cycle by performing the DRX cycle prediction based on an AI model corresponding to the one service type.

In an embodiment of the present disclosure, determining the second DRX cycle by performing the DRX cycle prediction based on the AI model corresponding to the service type set includes:

in response to the service type set including at least two service types, determining the second DRX cycle by performing the DRX cycle prediction based on an AI model corresponding to the at least two service types.

In an embodiment of the present disclosure, determining the second DRX cycle by performing the DRX cycle prediction based on the AI model corresponding to the service type set includes:

in response to the service type set including at least two service types and there being no AI model that corresponds to all the at least two service types, determining at least two fifth DRX cycles corresponding to the at least two service types based on AI models corresponding to the at least two service types, respectively;

determining the second DRX cycle based on the at least two fifth DRX cycles;

or,

in response to the service type set including at least two service types and there being no AI model that corresponds to all the at least two service types, performing the DRX cycle prediction without an AI model.

In an embodiment of the present disclosure, the method further includes:

sending a first model download request for a service set to the network device based on the service set run by the terminal; and

receiving an AI model sent by the network device for the first model download request, in which the AI model corresponds to a service type set of the service set.

In an embodiment of the present disclosure, the method further includes:

in response to a model download instruction for the AI model, sending a second model download request to the network device; and

receiving an AI model sent by the network device for the second model download request.

For a detailed description of the step 1901, reference may be made to a description of the above embodiments, which will not be repeated herein.

In an embodiment of the present disclosure, the second DRX cycle refers to a cycle determined by, in response to the AI model being deployed on the terminal, the terminal performing, based on the AI model, DRX cycle prediction for the service type set run by the terminal. The word “second” in the second DRX cycle is only used to distinguish it from other DRX cycles and does not specifically refer to a fixed cycle.

In an embodiment of the present disclosure, the AI model may be deployed on the terminal. In response to the AI model being deployed on the terminal, the terminal may determine the second DRX cycle by performing, based on the AI model, DRX cycle prediction for the service type set run by the terminal, and send the second DRX cycle to the network device.

Exemplarily, in an embodiment of the present disclosure, when the terminal sends the second DRX cycle to the network device, the network device may receive the second DRX cycle sent by the terminal. The network device may determine the first DRX cycle based on the second DRX cycle, or the network device may not determine the first DRX cycle based on the second DRX cycle.

In an embodiment of the present disclosure, the AI model is a model trained based on the service type corresponding to the AI model.

In summary, in the embodiments of the present disclosure, in response to the AI model being deployed on the terminal, the second DRX cycle is determined by performing, based on the AI model, DRX cycle prediction for the service type set run by the terminal; and the second DRX cycle is sent to the network device. In the embodiments of the present disclosure, the second DRX cycle is determined according to the AI model corresponding to the service type set run by the terminal, which may improve the accuracy of the determination of the second DRX cycle. The present disclosure provides a processing method for a situation of “determination of a DRX cycle”, so as to provide the DRX cycle determined based on the AI model corresponding to the service type set run by the terminal to the network device, which may improve the accuracy of the determination of the DRX cycle.

FIG. 20 is a flowchart of a method for determining a DRX cycle according to the embodiments of the present disclosure. The method is performed by a network device. As shown in FIG. 20, the method may include the following step 2001.

At step 2001, in response to the AI model being deployed on a terminal, a second DRX cycle determined based on the AI model by the terminal and sent by the terminal is received.

In an embodiment of the present disclosure, the AI model is a model trained based on the service type corresponding to the AI model.

For a detailed description of the step 2001, reference may be made to a description of the above embodiments, which will not be repeated herein.

In summary, in the embodiments of the present disclosure, in response to the AI model being deployed on the terminal, the second DRX cycle determined by the terminal based on the AI model and sent by the terminal is received. In the embodiments of the present disclosure, the second DRX cycle is determined according to the AI model corresponding to the service type set run by the terminal, which may improve the accuracy of the determination of the second DRX cycle. The present disclosure provides a processing method for a situation of “determination of a DRX cycle”, so as to receive the DRX cycle determined based on the AI model corresponding to the service type set run by the terminal and sent by the terminal, which may improve the accuracy of the determination of the DRX cycle.

FIG. 21 is a block diagram of an apparatus for determining a DRX according to the embodiments of the present disclosure. As shown in FIG. 21, the apparatus 2100, arranged on a terminal side, includes:

a receiving module 2101, configured to receive a first DRX cycle sent by a network device, in which the first DRX cycle is determined based on an AI model, and the AI model corresponds to a service type set run by the terminal.

In summary, in the apparatus for determining a DRX cycle in the embodiments of the present disclosure, the receiving module receives the first DRX cycle sent by the network device, in which the first DRX cycle is determined based on the AI model, and the AI model corresponds to the service type set run by the terminal. In the embodiments of the present disclosure, the first DRX cycle is determined according to the AI model corresponding to the service type set run by the terminal, which may reduce a situation that determination of the DRX cycle is inaccurate when different services perform DRX cycle prediction based on a same AI model, and improve the accuracy of the determination of the DRX cycle. The present disclosure provides a processing method for a situation of “determination of a DRX cycle”, so as to receive the DRX cycle determined based on the AI model corresponding to the service type set run by the terminal, which may reduce the situation that the determination of the DRX cycle is inaccurate when different services perform the DRX cycle prediction based on the same AI model, and improve the accuracy of the determination of the DRX cycle.

Optionally, in an embodiment of the present disclosure, the receiving module 2101, configured to receive the first DRX cycle sent by the network device, is specifically configured to:

in response to the AI model being deployed on the network device, receive the first

DRX cycle determined by the network device based on the AI model and sent by the network device.

Optionally, in an embodiment of the present disclosure, the receiving module 2101, configured to receive the first DRX cycle sent by the network device, is specifically configured to:

in response to the AI model being deployed on the terminal, determine a second DRX cycle by performing, based on the AI model, DRX cycle prediction for the service type set run by the terminal;

send the second DRX cycle to the network device; and

receive the first DRX cycle determined by the network device based on the second DRX cycle.

Optionally, in an embodiment of the present disclosure, the determining module 2102, configured to determine a second DRX cycle by performing, based on the AI model, DRX cycle prediction for a service type set run by the terminal, is specifically configured to:

classify a service set run by the terminal to determine a service type set of the service set; and

determine the second DRX cycle by performing the DRX cycle prediction based on the AI model corresponding to the service type set.

Optionally, in an embodiment of the present disclosure, a determining module 2102 is configured to determine the second DRX cycle by performing the DRX cycle prediction based on the AI model corresponding to the service type set, and is specifically configured to:

in response to the service type set including one service type, determine the second DRX cycle by performing the DRX cycle prediction based on an AI model corresponding to the one service type.

Optionally, in an embodiment of the present disclosure, the determining module 2102, configured to determine the second DRX cycle by performing the DRX cycle prediction based on the AI model corresponding to the service type set, is specifically configured to:

in response to the service type set including at least two service types, determine the second DRX cycle by performing the DRX cycle prediction based on an AI model corresponding to the at least two service types.

Optionally, in an embodiment of the present disclosure, the determining module 2102, configured to determine the second DRX cycle by performing the DRX cycle prediction based on the AI model corresponding to the service type set, is specifically configured to:

in response to the service type set including at least two service types and there being no AI model that corresponds to all the at least two service types, determine at least two fifth DRX cycles corresponding to the at least two service types based on AI models corresponding to the at least two service types, respectively;

determine the second DRX cycle based on the at least two fifth DRX cycles;

or,

in response to the service type set including at least two service types and there being no AI model that corresponds to all the at least two service types, perform the DRX cycle prediction without an AI model.

Optionally, in an embodiment of the present disclosure, the receiving module 2101 is further configured to:

send a first model download request for a service set to the network device based on the service set run by the terminal; and

receive an AI model sent by the network device for the first model download request, in which the AI model corresponds to a service type set of the service set.

Optionally, in an embodiment of the present disclosure, the receiving module 2101 is further configured to:

in response to a model download instruction for the AI model, send a second model download request to the network device; and

receive an AI model sent by the network device for the second model download request.

Optionally, in an embodiment of the present disclosure, the AI model is a model trained based on the service type corresponding to the AI model.

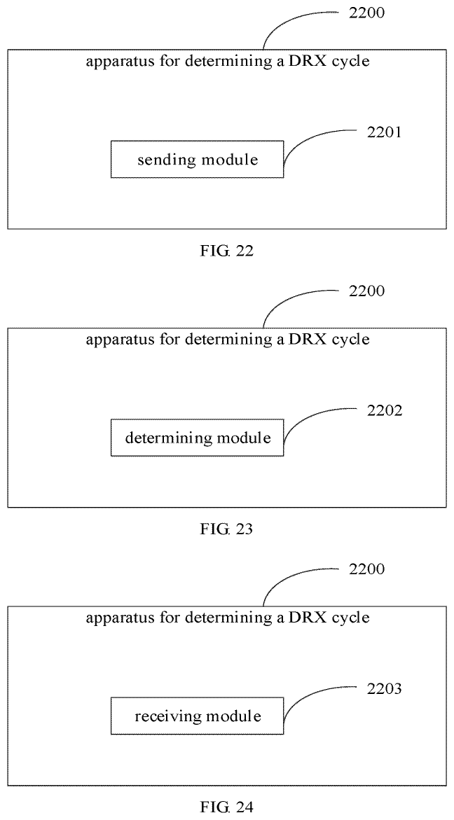

FIG. 22 is a block diagram of an apparatus for determining a DRX cycle according to the embodiments of the present disclosure. As shown in FIG. 22, the apparatus 2200, arranged on a network side, includes:

a sending module, configured to send a first DRX cycle to a terminal, in which the first DRX cycle is determined based on an AI model, and the AI model corresponds to a service type set run by the terminal.

In summary, in the apparatus for determining a DRX cycle in the embodiments of the present disclosure, the sending module is configured to send the first DRX cycle to the terminal, in which the first DRX cycle is determined based on the AI model, and the AI model corresponds to the service type set run by the terminal. In the embodiments of the present disclosure, the first DRX cycle is determined according to the AI model corresponding to the service type set run by the terminal, which may reduce a situation that determination of the DRX cycle is inaccurate when different services perform DRX cycle prediction based on a same AI model, and improve the accuracy of the determination of the DRX cycle. The present disclosure provides a processing method for a situation of “determination of a DRX cycle”, so as to send the DRX cycle determined based on the AI model corresponding to the service type set run by the terminal to the terminal, which may reduce the situation that the determination of the DRX cycle is inaccurate when different services perform the DRX cycle prediction based on the same AI model, and improve the accuracy of the determination of the DRX cycle.

Optionally, in an embodiment of the present disclosure, FIG. 23 is a block diagram of an apparatus for determining a DRX cycle according to the embodiments of the present disclosure. As shown in FIG. 23, the apparatus 2200, arranged on a network side, further includes a determining module 2202. The determining module 2202, before sending the first DRX cycle to the terminal, is configured to:

in response to the AI model being deployed on the network device, generate a third DRX cycle by performing, based on the AI model, DRX cycle prediction for the service type set run by the terminal; and

determine the first DRX cycle according to the third DRX cycle.

Optionally, in an embodiment of the present disclosure, the determining module 2202, configured to determine the third DRX cycle by performing, based on the AI model, DRX cycle prediction for the service type set run by the terminal, is specifically configured to:

classify a service set run by the terminal to determine a service type set of the service set; and

determine the third DRX cycle by performing the DRX cycle prediction based on the AI model corresponding to the service type set.

Optionally, in an embodiment of the present disclosure, the determining module 2202, configured to determine the third DRX cycle by performing the DRX cycle prediction based on the AI model corresponding to the service type set, is configured to:

in response to the service type set including one service type, determine the third DRX cycle by performing the DRX cycle prediction based on an AI model corresponding to the one service type.

Optionally, in an embodiment of the present disclosure, the determining module 2202, configured to determine the third DRX cycle by performing the DRX cycle prediction based on the AI model corresponding to the service type set, is configured to:

in response to the service type set including at least two service types, determine the third DRX cycle by performing the DRX cycle prediction based on an AI model corresponding to the at least two service types.

Optionally, in an embodiment of the present disclosure, the determining module 2202, configured to determine the third DRX cycle by performing the DRX cycle prediction based on the AI model corresponding to the service type set, is configured to:

in response to the service type set including at least two service types and there being no AI model that corresponds to all the at least two service types, determine at least two fourth DRX cycles corresponding to the at least two service types based on AI models corresponding to the at least two service types, respectively;

determine the third DRX cycle based on the at least two fourth DRX cycles;

or,

in response to the service type set including at least two service types and there being no AI model that corresponds to all the at least two service types, perform the DRX cycle prediction without an AI model.

Optionally, in an embodiment of the present disclosure, FIG. 24 is a block diagram of an apparatus for determining a DRX cycle according to the embodiments of the present disclosure. As shown in FIG. 24, the apparatus 2200, arranged on a network side, further includes a receiving module 2203. The receiving module 2203, before sending the first DRX cycle to the terminal, is configured to:

in response to the AI model being deployed on the terminal, receive a second DRX cycle determined by the terminal based on the AI model and sent by the terminal; and

determine the first DRX cycle according to the second DRX cycle.

Optionally, in an embodiment of the present disclosure, the sending module 2201 is further configured to:

receive a first model download request sent by the terminal, in which the first model download request is a request for a service set run by the terminal; and

send an AI model for the first model download request to the terminal, in which the AI model corresponds to a service type set of the service set.

Optionally, in an embodiment of the present disclosure, the sending module 2201 is further configured to:

receive a second model download request sent by the terminal for a model download instruction of the AI model; and

send the AI model for the second model download request to the terminal.

Optionally, in an embodiment of the present disclosure, the AI model is a model trained based on the service type corresponding to the AI model.

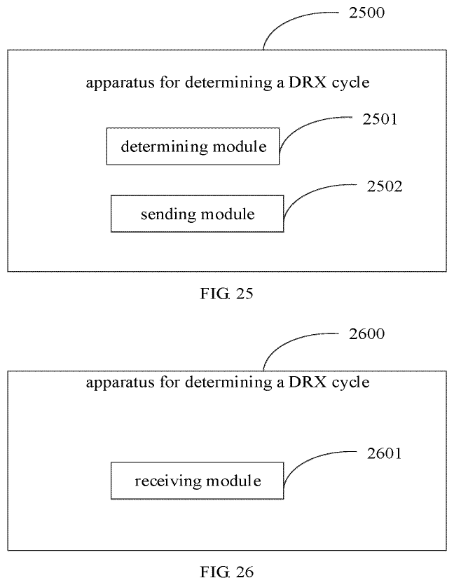

FIG. 25 is a block diagram of an apparatus for determining a DRX cycle according to the embodiments of the present disclosure. As shown in FIG. 25, the apparatus 2500, arranged on a terminal side, may further include a determining module 2501 and a sending module 2502.

The determining module 2501 is configured to, in response to an AI model being deployed on the terminal, determine a second DRX cycle by performing, based on the AI model, DRX cycle prediction for a service type set run by the terminal; and

the sending module 2502 is configured to send the second DRX cycle to a network device.

In summary, in the apparatus for determining a DRX cycle in the embodiments of the present disclosure, the determining module is configured to, in response to the AI model being deployed on the terminal, determine the second DRX cycle by performing, based on the AI model, DRX cycle prediction for the service type set run by the terminal; and the sending module is configured to send the second DRX cycle to the network device. In the embodiments of the present disclosure, the second DRX cycle is determined according to the AI model corresponding to the service type set run by the terminal, which may improve the accuracy of the determination of the second DRX cycle. The present disclosure provides a processing method for a situation of “determination of a DRX cycle”, so as to provide the DRX cycle determined based on the AI model corresponding to the service type set run by the terminal to the network device, which may improve the accuracy of the determination of the DRX cycle.

Optionally, in an embodiment of the present disclosure, the determining module 2501, configured to determine the second DRX cycle by performing, based on the AI model, DRX cycle prediction for a service type set run by the terminal, is specifically configured to:

classify a service set run by the terminal to determine a service type set of the service set; and

determine the second DRX cycle by performing the DRX cycle prediction based on the AI model corresponding to the service type set.

Optionally, in an embodiment of the present disclosure, the determining module 2501, configured to determine the second DRX cycle by performing the DRX cycle prediction based on the AI model corresponding to the service type set, is specifically configured to:

in response to the service type set including one service type, determine the second DRX cycle by performing the DRX cycle prediction based on an AI model corresponding to the one service type.

Optionally, in an embodiment of the present disclosure, the determining module 2501, configured to determine the second DRX cycle by performing the DRX cycle prediction based on the AI model corresponding to the service type set, is specifically configured to:

in response to the service type set including at least two service types, determine the second DRX cycle by performing the DRX cycle prediction based on an AI model corresponding to the at least two service types.

Optionally, in an embodiment of the present disclosure, the determining module 2501, configured to determine the second DRX cycle by performing the DRX cycle prediction based on the AI model corresponding to the service type set, is specifically configured to:

in response to the service type set including at least two service types and there being no AI model that corresponds to all the at least two service types, determine at least two fifth DRX cycles corresponding to the at least two service types based on AI models corresponding to the at least two service types, respectively;

determine the second DRX cycle based on the at least two fifth DRX cycles;

or,

in response to the service type set including at least two service types and there being no AI model that corresponds to all the at least two service types, perform the DRX cycle prediction without an AI model.

Optionally, in an embodiment of the present disclosure, the sending module 2502 is further configured to:

send a first model download request for a service set to the network device based on the service set run by the terminal; and

receive an AI model sent by the network device for the first model download request, in which the AI model corresponds to a service type set of the service set.

Optionally, in an embodiment of the present disclosure, the sending module 2502 is further configured to:

in response to a model download instruction for the AI model, send a second model download request to the network device; and

receive an AI model sent by the network device for the second model download request.

FIG. 26 is a block diagram of an apparatus for determining a DRX cycle according to the embodiments of the present disclosure. As shown in FIG. 26, the apparatus 2600, arranged on a terminal side, may include a receiving module 2601.

The receiving module 2601 is configured to, in response to an AI model being deployed on a terminal, receive a second DRX cycle determined by the terminal based on the AI model and sent by the terminal.

In summary, in the apparatus for determining a DRX cycle in the embodiments of the present disclosure, the receiving module is configured to, in response to the AI model being deployed on the terminal, receive the second DRX cycle determined by the terminal based on the AI model and sent by the terminal. In the embodiments of the present disclosure, the second DRX cycle is determined according to the AI model corresponding to the service type set run by the terminal, which may improve the accuracy of the determination of the second DRX cycle.

The present disclosure provides a processing method for a situation of “determination of a DRX cycle”, so as to receive the DRX cycle determined based on the AI model corresponding to the service type set run by the terminal and sent by the terminal, which may improve the accuracy of the determination of the DRX cycle.

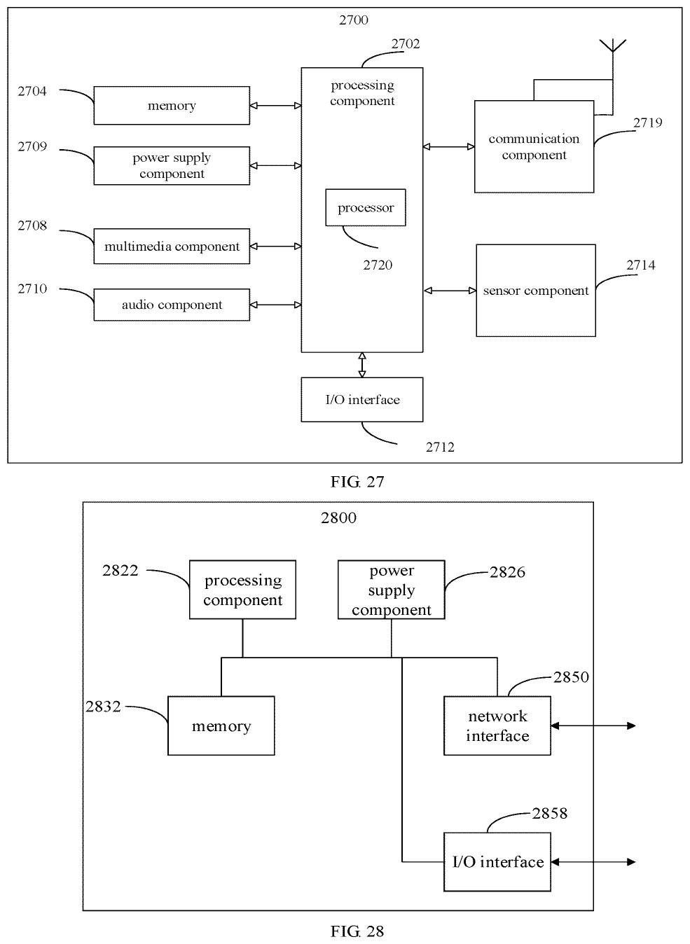

FIG. 27 is a block diagram of a terminal UE 2700 according to an embodiment of the present disclosure. For example, the UE 2700 may be a mobile phone, computer, digital broadcast terminal, message transceiver, game console, tablet device, medical device, fitness device, personal digital assistant, etc.

Referring to FIG. 27, the UE 2700 may include at least one of the following components: a processing component 2702, a memory 2704, a power supply component 2706, a multimedia component 2708, an audio component 2710, an input/output (I/O) interface 2712, a sensor component 2714, and a communication component 2716.

The processing component 2702 typically controls the overall operation of the UE 2700, such as those associated with display, telephone calls, data communication, camera operation, and recording operations. The processing component 2702 may include at least one processor 2720 to execute instructions to complete all or part of the blocks of the method described above. In addition, the processing component 2702 may include at least one module to facilitate the processing of interactions between the component 2702 and other components. For example, the processing component 2702 may include a multimedia to facilitate the interaction between the multimedia 2708 and the processing component 2702.

The memory 2704 is configured to store various types of data to support operations in the UE 2700. Examples of such data include instructions for any application or method used to operate on the UE 2700, contact data, phone book data, messages, pictures, videos, etc. The memory 2704 may be implemented by any type of volatile or non-volatile memory or a combination of them, such as static random access memory (SRAM), electrically erasable programmable read-only memory (EEPROM), erasable programmable read-only memory (EPROM), programmable read-only memory (PROM), read-only memory (ROM), magnetic memory, flash memory, disk or CD.

The power supply component 2706 provides power to the various components of the UE 2700. The power supply module 2706 may include a power management system, at least one power supply, and other components associated with generating, managing, and distributing power for the UE 2700.

The multimedia component 2708 includes a screen providing an output interface between the UE 2700 and the user. In some embodiments, the screen may include a liquid crystal display (LCD) and a touch panel (TP). If the screen includes a touch panel, the screen may be implemented as a touch screen to receive input signals from the user. The touch panel includes at least one touch sensor to sense touch, swiping, and gestures on the touch panel. The touch sensor may not only sense the boundaries of the touch or slide action, but also detect the wake time period and pressure associated with the touch or slide operation. In some embodiments, the multimedia component 2708 includes a front camera and/or a rear camera. When the UE 2700 is in an operation mode, such as a shooting mode or a video mode, the front camera and/or rear camera may receive external multimedia data. Each front camera and rear camera may be a fixed optical lens system or have focal length and optical zoom capabilities.

The audio component 2710 is configured to output and/or input audio signals. For example, the audio component 2710 includes a microphone (MIC) that is configured to receive external audio signals when the UE 2700 is in operation mode, such as a call mode, a recording mode, and a speech recognition mode. The received audio signal may be further stored in the memory 2704 or transmitted via a communication component 2716. In some embodiments, the audio component 2710 also includes a loudspeaker for outputting an audio signal.

The I/O interface 2712 provides an interface between the processing component 2702 and the peripheral interface module, which may be a keyboard, a click wheel, a button, etc. The button may include, but are not limited to: a home button, a volume button, a start button, and a lock button.

The sensor component 2714 includes at least one sensor to provide a condition assessment of all aspects of the UE 2700. For example, the sensor component 2714 may detect the on/off state of the UE 2700, the relative positioning of the components, such as the display and keypad of the UE 2700, the sensor component 2714 may also detect changes in the position of the UE 2700 or one of the components of the UE 2700, the presence or absence of contact between the user and the UE 2700, position or acceleration/deceleration of the UE 2700 and temperature change of the UE 2700. The sensor component 2714 may include a proximity sensor configured to detect the presence of nearby objects in the absence of any physical contact. The sensor component 2714 may also include an optical sensor, such as a CMOS or CCD image sensor, for use in imaging applications. In some embodiments, the sensor component 2714 may also include an acceleration sensor, a gyroscope sensor, a magnetic sensor, a pressure sensor, or a temperature sensor.

The communication component 2716 is configured to facilitate wired or wireless communication between the UE 2700 and other devices. The UE 2700 may access wireless networks based on communication standards, such as WiFi, 2G or 3G, or a combination of them. In one exemplary embodiment, the communication component 2716 receives broadcast signals or from an external broadcast management system broadcast-related information via a broadcast channel. In an exemplary embodiment, the communication component 2716 also includes a near-field communication (NFC) module to facilitate short-range communication. For example, the NFC module may be implemented based on radio frequency identification (RFID) technology, infrared data association (IrDA) technology, ultra-wideband (UWB) technology, bluetooth (BT) technology and other technologies.

In an exemplary embodiment, the UE 2700 may be used to perform the above methods by implementing by at least one application specific integrated circuit (ASIC), digital signal processor (DSP), digital signal processing device (DSPD), programmable logic device (PLD), field programmable gate array (FPGA), controller, microcontroller, microprocessor, or other electronic components.

FIG. 28 is a block diagram of a network device 2800 according to the embodiments of the present disclosure. For example, the network device 2800 may be provided as a network device. Referring to FIG. 28, the network device 2800 includes a processing component 2822, which further includes at least one processor, and memory resources represented by a memory 2832 for storing instructions, such as applications, that may be executed by the processing component 2822. The applications stored in memory 2832 may include one or more modules each corresponds to a set of instructions. In addition, the processing component 2822 is configured to execute the instructions to implement any one of the methods applied to the network device, such as the method shown in FIG. 10.

The network device 2800 may also include a power supply component 2826 configured to perform power management of the network device 2800, a wired or wireless network interface 2850 configured to connect the network device 2800 to the network, and an input/output (I/O) interface 2858. The network device 2800 may operate based on an operating system stored in memory 2832, such as Windows Server TM, Mac OS XTM, Unix TM, Linux TM, Free BSDTM and so on.

In the embodiments of the present disclosure, the method provided in the embodiments of the present disclosure is introduced respectively from the perspectives of the network device and the UE. In order to implement the functions in the method provided by the above embodiments, the network device and UE may include a hardware structure, and a software module, and may implement the above functions by the hardware structure, the software module or the hardware structure and a software module. One of these functions may be performed as a hardware structure, a software module, or a hardware structure and a software module.

In the embodiments of the present disclosure, the method provided in the embodiments of the present disclosure is introduced respectively from the perspectives of the network device and the UE. In order to implement the functions in the method provided by the above embodiments, the network device and UE may include a hardware structure, and a software module, and may implement the above functions by the hardware structure, the software module or the hardware structure and a software module. One of these functions may be performed as a hardware structure, a software module, or a hardware structure and a software module.

The embodiments of the present disclosure provide a communication device. The communication device may include a transceiver module and a processing module. The transceiver module may include a transmitting module and/or a receiving module, the transmitting module is configured to achieve the transmitting function, the receiving module is configured to achieve the receiving function, and the transceiver module may achieve the transmitting function and/or receiving function.

The communication device may be a terminal (such as the terminal in the above method embodiments), a device in a terminal, or a device that may be used with a terminal, or, the communication device may be a network device, a device in a network device, or a device that may be used with a network device.

The embodiments of the present disclosure provide another communication device. The communication device may be a network device, or a terminal (such as the terminal in the above method embodiments), or a chip, a chip system, a processor, etc. that supports the network device to implement the method, or a chip, a chip system, a processor, etc. that supports the terminal to implement the method. The device is configured to implement the method in the above method embodiments. For details, reference may be made to the descriptions in the above method embodiments.

The communication device may include one or more processors. The processor may be a general-purpose processor or a special-purpose processor. For example, it may be a baseband processor or a central processing unit. The baseband processor is configured to process communication protocols and communication data, and the central processor is configured to control communication devices (such as base stations, baseband chips, terminals, terminal chips, distributed units (DUs) or a central unit (CU), etc.) to execute computer programs and process computer program data.

Optionally, the communication device may also include one or more memories on each of which a computer program is stored. When the computer program is executed by the processor, the communication device performs the method in the above method embodiments. Optionally, the memory may also store data. The communication device and the memory may be set separately or integrated together.

Optionally, the communication device includes a transceiver and an antenna. The transceiver may be called a transceiving unit, a transceiving machine, or a transceiving circuit, etc., to implement the transceiving function. The transceiver includes a receiver and a transmitter. The receiver may be called a receiver or a receiving circuit, etc., for realizing the receiving function; and the transmitter may be called a transmitter or a transmitting circuit, etc., to implement the transmitting function.

Optionally, the communication device includes one or more interface circuits. The interface circuit is configured to receive code instructions and transmit the code instructions to the processor. When the code instructions are running on the processor, the communication device is caused to implement the method in the above embodiments.

When the communication device is a terminal (such as the terminal in the above method embodiments), the processor is configured to execute the method according to any one of FIG. 1 to FIG. 9 and FIG. 19.

When the communication device is a network device, the processor is configured to execute the method according to any one of FIG. 10 to FIG. 18 and FIG. 20.

In an implementation, the processor includes a transceiver for implementing the receiving and transmitting functions. For example, the transceiver may be a transceiving circuit, or an interface, or an interface circuit. The transceiving circuits, interfaces, or interface circuits configured to perform the receiving and transmitting functions may be separate or integrated together. The transceiving circuit, interface or interface circuit may be configured to read and write code/data, or the transceiving circuit, interface or interface circuit may be configured to transmit signals.

In an embodiment, the processor stores a computer program. When the computer program is running on the processor, the communication device is caused to perform the method in the above embodiments. The computer program may be solidified in the processor. In this way, the processor may be implemented in hardware.

In an embodiment, the communication device includes a circuit that may implement the transmitting or receiving or communicating function in the above method embodiments. The processors and the transceiver in the disclosure may be implemented in an integrated circuit (IC), an analog IC, a radio frequency integrated circuit (RFIC), a mixed-signal IC, an application specific integrated circuit (ASIC), a printed circuit board (PCB), an electronic equipment, etc. The processor and transceiver may also be manufactured with various IC process technologies, such as a complementary metal oxide semiconductor (CMOS), nMetal-oxide-semiconductor (NMOS), a positive channel metal oxide semiconductor (PMOS), bipolar junction transistor (BJT), a bipolar CMOS (BiCMOS), silicon germanium (SiGe), gallium arsenide (GaAs), etc.

The communication device in the above embodiments may be a network device or a terminal (such as the terminal in the above method embodiments), but the scope of the communication device in the disclosure is not limited to this, and the structure of the communication device may not be restricted. The communication device may be an independent device or part of a larger device. For example, the communication device may be:

(1) an independent IC, or a chip, or a chip system or a subsystem;

(2) a collection including one or more ICs, optionally, the IC collection may also include a storage component for storing data and computer programs;

(3) an ASIC, such as a modem;

(4) modules embedded in other devices;

(5) a receiver, a terminal, an intelligent terminal, a cellular phone, a wireless device, a handheld phone, a mobile unit, a vehicle-mounted device, a network device, a cloud device, an artificial intelligence device, etc.;

(6) others.

For the case where the communication device may be a chip or a chip system, the chip includes the processor and the interface. There may be one or more processors, and there may be a plurality of interfaces.

Optionally, the chip also includes a memory, which is configured to store necessary computer programs and data.

Those skilled in the art may also understand that the various illustrative logical blocks and steps listed in the embodiments of the present disclosure may be implemented by electronic hardware, computer software, or their combination. Whether such a function is implemented in hardware or software depends on specific applications and design requirements of the overall system. Those skilled in the art may, for each specific application, use a variety of methods to achieve the above functions, but such implementation shall not be regarded as going beyond the scope of the protection of the embodiments of the present disclosure.

The disclosure also provides a computer-readable storage medium for storing instructions. When the instructions are executed by a computer, the function of any of the above method embodiments is implemented.

The disclosure also provides a computer program product. When the computer program product is executed by a computer, the functions of any of the above method embodiments is implemented.

In the above embodiments, all or part of them may be implemented by software, hardware, firmware, or any combination of them. When implemented by software, the functions may be implemented in whole or in part in the form of a computer program product. The computer program product includes one or more computer programs. All or part of the procedures or functions according to embodiments of the present disclosure are generated when the computer program is loaded and executed on a computer. The computer may be a general purpose computer, a special purpose computer, a computer network, or other programmable device. The computer program may be stored in a computer-readable storage medium or transmitted from one computer-readable storage medium to another. For example, the computer program may be transmitted from one website, computer, server, or data center to another website, computer, server, or data center via a wired (such as a coaxial cable, a fiber optic, a digital subscriber line (DSL)) or a wireless (such as infrared, radio, microwave) way. The computer-readable storage medium may be any available medium that may be accessed by a computer, or a data storage device such as a server that integrates one or more of the available media, and a data center. The available medium media be a magnetic medium (such as a floppy disk, a hard disk and a magnetic tape), an optical medium (such as a digital video disk (DVD)), or a semiconductor medium (such as a solid state disk (SSD)).

Those skilled in the art may understand that various numbers such as first and second involved in the present disclosure are distinguished merely for convenience of description, and are not intended to limit the scope of embodiments of the present disclosure, also not to indicate an order of precedence.

The term “at least one” in the present disclosure may also be described as one or more, and the term “a plurality of” may be two, three, four or more, which is not limited in the present disclosure. In embodiments of the present disclosure, for a kind of technical feature, technical features in the kind of technical feature are distinguished by “first”, “second”, “third”, “A”, “B”, “C” and “D”, and there is no order of precedence or magnitude between technical features described in “first”, “second”, “third”, “A”, “B”, “C” and “D”.

Those skilled in the art, after considering the specification and practicing the disclosure disclosed herein, will readily think of other embodiments of the present disclosure. This disclosure is intended to cover any variation, use, or adaptation of the disclosure that follows the general principles of the disclosure and includes common knowledge or conventional technical means in the field of technology that are not disclosed in this disclosure. The specification and embodiments are considered as examples, and the true scope and spirit of this disclosure are indicated by the claims below.

It may be understood that this disclosure is not limited to the precise structure already described above and illustrated in the attached drawings, and that various modifications and changes may be made without departing from its scope. The scope of this disclosure is limited only by the attached claims.

1. A method for determining a discontinuous reception (DRX) cycle, performed by a terminal, comprising:
receiving a first DRX cycle sent by a network device, wherein the first DRX cycle is determined based on an artificial intelligence (AI) model, and the AI model corresponds to a service type set run by the terminal.

2. The method of claim 1, wherein receiving the first DRX cycle sent by the network device comprises:
in response to the AI model being deployed on the network device, receiving the first DRX cycle determined by the network device based on the AI model and sent by the network device.

3. The method of claim 1, wherein receiving the first DRX cycle sent by the network device comprises:
in response to the AI model being deployed on the terminal, determining a second DRX cycle by performing, based on the AI model, DRX cycle prediction for the service type set run by the terminal;
sending the second DRX cycle to the network device; and
receiving the first DRX cycle determined by the network device based on the second DRX cycle.

4. The method of claim 1, wherein the Al model is a model trained based on a service type corresponding to the AI model.

5. A method for determining a discontinuous reception (DRX) cycle, performed by a network device, comprising:
sending a first DRX cycle to a terminal, wherein the first DRX cycle is determined based on an artificial intelligence (AI) model, and the AI model corresponds to a service type set run by the terminal.

6. The method of claim 5, wherein before sending the first DRX cycle to the terminal, the method further comprises:
in response to the AI model being deployed on the network device, generating a third DRX cycle by performing, based on the AI model, DRX cycle prediction for the service type set run by the terminal; and
determining the first DRX cycle according to the third DRX cycle.

7. The method of claim 6, wherein determining the third DRX cycle by performing, based on the AI model, DRX cycle prediction for the service type set run by the terminal, comprises:
classifying a service set run by the terminal to determine a service type set of the service set; and
determining the third DRX cycle by performing the DRX cycle prediction based on the AI model corresponding to the service type set.

8. The method of claim 7, wherein determining the third DRX cycle by performing the DRX cycle prediction based on the AI model corresponding to the service type set comprises at least one of:
in response to the service type set comprising one service type, determining the third DRX cycle by performing the DRX cycle prediction based on an AI model corresponding to the one service type;
in response to the service type set comprising at least two service types, determining the third DRX cycle by performing the DRX cycle prediction based on an AI model corresponding to the at least two service types; or in response to the service type set comprising at least two service types and there being no AI model that corresponds to all the at least two service types, determining at least two fourth DRX cycles corresponding to the at least two service types based on AI models corresponding to the at least two service types, respectively;
determining the third DRX cycle based on the at least two fourth DRX cycles; or in response to the service type set comprising at least two service types and there being no Al model that corresponds to all the at least two service types, performing the DRX cycle prediction without an AI model.

9-10. (canceled)

11. The method of claim 5, wherein before sending the first DRX cycle to the terminal, the method further comprises:
in response to the AI model being deployed on the terminal, receiving a second DRX cycle determined by the terminal based on the AI model and sent by the terminal; and
determining the first DRX cycle according to the second DRX cycle.

12. The method of claim 5, further comprising:
receiving a first model download request sent by the terminal, wherein the first model download request is a request for a service set run by the terminal; and
sending an AI model for the first model download request to the terminal, wherein the AI model corresponds to a service type set of the service set.

13. The method of claim 5, further comprising:
receiving a second model download request sent by the terminal for a model download instruction for the AI model; and
sending the AI model for the second model download request to the terminal.

14. The method of claim 5, wherein the AI model is a model trained based on a service type corresponding to the AI model.

15. (canceled)

16. The method of claim 3, wherein determining the second DRX cycle by performing, based on the AI model, DRX cycle prediction for the service type set run by the terminal, comprises:
classifying a service set run by the terminal to determine a service type set of the service set; and
determining the second DRX cycle by performing the DRX cycle prediction based on the AI model corresponding to the service type set.

17. The method of claim 16, wherein determining the second DRX cycle by performing the DRX cycle prediction based on the AI model corresponding to the service type set comprises:
in response to the service type set comprising one service type, determining the second DRX cycle by performing the DRX cycle prediction based on an AI model corresponding to the one service type;
in response to the service type set comprising at least two service types, determining the second DRX cycle by performing the DRX cycle prediction based on an AI model corresponding to the at least two service types; or
in response to the service type set comprising at least two service types and there being no AI model that corresponds to all the at least two service types, determining at least two fifth DRX cycles corresponding to the at least two service types based on AI models corresponding to the at least two service types, respectively;
determining the second DRX cycle based on the at least two fifth DRX cycles; or
in response to the service type set comprising at least two service types and there being no AI model that corresponds to all the at least two service types, performing the DRX cycle prediction without an AI model

18-19. (canceled)

20. The method of claim 1, further comprising:
sending a first model download request for a service set to the network device based on the service set run by the terminal; and
receiving an Al model sent by the network device for the first model download request, wherein the AI model corresponds to a service type set of the service set.

21. The method of claim 1, further comprising:
in response to a model download instruction for the AI model, sending a second model download request to the network device; and
receiving an AI model sent by the network device for the second model download request.

22-26. (canceled)

27. A terminal, comprising a processor and a memory for storing a computer program, wherein the processor is configured to:
receive a first DRX cycle sent by a network device, wherein the first DRX cycle is determined based on an artificial intelligence (AI) model, and the AI model corresponds to a service type set run by the terminal.

28. A network device, comprising:
a processor; and
a memory for storing instructions executable by the processor,
wherein the processor is configured to perform the method of claim 5.

29-30. (canceled)

31. A non-transitory_computer-readable storage medium for storing instructions, wherein when the instructions are executed, the method of claim 1 is implemented.

32. A non-transitory_computer-readable storage medium for storing instructions, wherein when the instructions are executed, the method of claim 5 implemented.
